(19) United States
(12) Patent Application Publication
(10) Pub. No.: US 2012/0220684 A1
(43) Pub. Date: Aug. 30, 2012

(54) CURABLE FORMULATION

(76) Inventors: Ian Bryson, Edinburgh (GB); Jiaqian Li, Edinburgh (GB); Ian Malcom MacKinnon, Darlington (GB); Jinglan Zhang, Shanghai (CN)

(21) Appl. No.: 13/394,626

(22) PCT Filed: Sep. 7, 2010
(86) PCT No.: PCT/GB2010/051492

§ 371 Date: May 15, 2012

(30) Foreign Application Priority Data
Sep. 8, 2009 (GB) 0915672.0
Sep. 8, 2009 (GB) 0915674.6

(51) Int. Cl. C09D 11/10; C09D 163/00; C08L 63/00; C08G 63/91

(52) U.S. Cl. 522/170; 528/365; 523/400; 525/523; 525/533; 525/524; 523/427

(57) ABSTRACT

Disclosed is a curable formulation comprising a resin; all, or a substantial part, of which comprises one or more fatty acid esters, or their derivatives, obtained from plant oils. Due to the high viscosity of known curable resin materials, and in particular cationically photocurable and thermally curable resins epoxy resins, reactive diluents are conventionally added in order to reduce viscosity and render them suitable for certain methods of application, such as flexography and inkjet printing. However, if an excessive amount of reactive diluent is added to a formulation, the concentration of resin may be so low as to prevent a formulation from curing to form a cured, cross-linked material with acceptable properties. Thus the minimum viscosity of known formulations is limited by the amount of low viscosity reactive diluent which may be added to comparatively high viscosity resins. Formulations of the present invention comprise resins of lower viscosity and therefore may be prepared having a lower viscosity than has been previously possible.

### FIELD OF THE INVENTION

The invention relates in general to the field of curable formulations and in particular to the field of cationically photocurable and thermally curable coating formulations.

### BACKGROUND TO THE INVENTION

It is known to provide curable formulations for surface treatment applications, such as inks, varnishes and other protective surface treatments, paint and adhesives.

Curable formulations typically comprise polymeric or oligomeric resin material and, optionally, additional components such as cross linkers, diluents and initiators. During curing, the resin material (and, optionally, other components of the formulation) reacts to form a cured, cross-linked material.

Curable formulations have a number of advantages over traditional drying formulations. Curable formulations need not comprise a substantial amount of solvent (although solvents may be used) and therefore typically release lower quantities of volatile organic compounds (VOC's) into the atmosphere than drying formulations, and have reduced problems of cracking and/or low surface adhesion caused by shrinkage. Cured, cross-linked materials obtained from curable formulations are also typically more chemically and physically robust than materials obtained from drying formulations, due to the additional chemical bonding between components of the resin material.

Additionally, the curing reaction of a curable formulation offers a greater degree of control over the formation of a coating. Typically the curing reaction is initiated by an external stimulus such as an increase in temperature, exposure to light, or an electron beam, and will not significantly proceed until that stimulus is provided.

The facility to control the onset of curing and, in some instances, cause very rapid formation of a cured material, is particularly suitable to many modern manufacturing and printing methods. In contrast, many drying formulations suffer from comparatively limited storage lifetime, due to the evaporation of solvent during storage, typically take longer to dry to form a finished coating, and/or require considerable heat energy to drive off the solvent and accelerate the drying process.

A number of different curing systems are known. Curable formulations may be thermally cured, or radiation cured. In many applications, radiation curing is advantageous, since a source of radiation (such as ultraviolet radiation, or an electron beam) may be more readily controlled than a source of heat. In some applications and for some substrates (for example delicate plastics or paper substrates, or natural materials such as wood) it may be vital to keep processing temperatures low. Furthermore, radiation curing is generally more energy efficient than thermal curing. However, radiation curing (and in particular UV curing) may require special curing apparatus and, in certain applications (for example coating of large surface areas, or of irregularly shaped items) thermal curing may be most practicable.

Radiation and thermally curable formulations typically comprise an initiator. Two main classes of initiator are commonly used; radical initiators, which absorb radiation or heat to release a radical species, such as a peroxide radical, and cationic initiators, which react to form a superacid species. Other classes of initiator are known. Different curing chemistries require the use of different classes of initiator. For example, radical initiators are most suitable to react with carbon-carbon double bonds, whereas cationic initiators are most suitable to initiate cross linking at epoxide groups or vinyl ethers.

For certain applications, cationic curing conveys a number of advantages over radical curing. Radical reactions are inhibited by oxygen, which may lead to incomplete curing and unsatisfactory properties of the resultant cured, cross-linked material. For example, a cured coating material may remain tacky, or suffer from low adhesion to a substrate. By contrast, cationic curing reactions are not inhibited by oxygen.

In addition, whereas a radical chain reaction will quickly come to an end in the absence of a radiation source (usually light) or other energy source, a cationic chain reaction will continue in the absence of a radiation or other energy source (in some cases to completion) once initiated. Therefore, cationic, radiation initiated curing may convey processing advantages, since a cationically curable sample needs to be resident under a light (or other suitable energy) source for a shorter period of time than a radical curable sample.

In the case of cationic curing of epoxidized resins, shrinkage during curing is lower than radical curing of unsaturated hydrocarbon resins (i.e. at carbon-carbon (and carbon-heteroatom) double bonds). This may be particularly advantageous for surface coating applications, where shrinkage can result in poor surface adhesion.

Additional materials may be added to a curable formulation to adjust the properties of both the curable formulation and the cured cross-linked material. For example, a diluent may be added to reduce the viscosity of the formulation. Low viscosity may be a requirement of certain printing applications (such as flexography, gravure or inkjet printing) or other coatings applications (such as wood treatment and some printing applications, where it may be desirable for a formulation to penetrate a surface).

Reactive diluents, which comprise functional groups suitable to participate in the curing reaction, are often used in preference to passive diluents, to avoid release of VOC's and problems caused by shrinkage.

Reactive modifiers, such as polyols, may also be added to enhance the properties of the cured material, functioning as cross linkers and/or as plasticizers by increasing or decreasing the amount, or density, of cross linking which takes place.

As with all plastics materials, other passive components, such as pigments and plasticizers, may also be added.

Known cationically curable formulations are typically based upon synthetic epoxidized resins. Such resins have a relatively high viscosity, and they are unsuitable for applications requiring low viscosity. The viscosity of formulations comprising these resins may be lowered by the addition of reactive diluents.

However, reactive diluents are also known to affect properties of the cured material. For example, the viscosity of epoxide based coating systems such as Cyracure (Cyracure is a Trade Mark of the Dow Chemical Company) may be reduced by addition of small molecule reactive diluents such as limonene dioxide or cyclohexene oxide, however the minimum viscosity is limited, since the properties of the cured material become unacceptable (for example, coatings formulations become brittle and lack surface adhesion) when the amount of such reactive diluents in the curable formulation exceeds a certain level.

The deleterious effects of reactive diluents may be compensated for to some extent by the addition of plasticizers or other additives. However, this increases the overall cost of a formulation, and may be environmentally damaging, as both passive and unreacted active components tend to leach out of cured cross-linked materials over time and may be toxic when they enter the environment. Furthermore, each additional component requires additional energy and resources to manufacture or refine and, in the case of plant derived materials such as soya and linseed oil (which may be used as passive diluents), there may be competition with food crops and/or the requirement to clear natural environment to make way for additional agricultural use.

Consequently, despite their inherent advantages, the use of cationically curable formulations in applications requiring low viscosity is limited.

For example, flexographic printing applications preferably require inks having viscosities less than approximately 65 cP, and may be less than 65 cP or more preferably as low as 20-30 cP. Known curable formulations, such as cationically UV-curable epoxide based formulations (for example, Cyracure) have viscosities in excess of 100 cP, even after the maximum amount of reactive diluent has been added. Lower viscosities may only be achieved by the addition of a volatile solvent such as isopropyl alcohol. The resulting flexographic ink formulations must therefore be regarded as hybrid systems which are part drying and part curing. Accordingly, VOC emissions are relatively high and formulations suffer from some of the problems of trying to formulations such as shrinkage. As a result, radical curing formulations are generally preferred for industrial applications.

Thus, there remains a need for curable formulations which are both cost effective, environmentally friendly and which are suitable for low viscosity applications.

### SUMMARY OF THE INVENTION

According to a first aspect of the invention there is provided a cationically curable formulation comprising a resin;

all, or a substantial part, of the resin comprising (or, in some embodiments, consisting of) one or more fatty acid esters, or derivatives thereof, wherein each said fatty acid ester is not a mono-, di- or triglyceride.

The resin may be an epoxy resin. The formulation may be curable by any suitable means. In some embodiments, the formulation is photocurable and in some embodiments, the formulation is thermally curable. The invention thus extends in a further aspect to a cationically curable (for example photocurable or thermally curable) formulation comprising an epoxy resin; all, or a substantial part, of the resin comprising one or more epoxidized fatty acid esters, or derivatives thereof, wherein each said epoxidized fatty acid ester is not a mono-, di- or triglyceride.

The fatty acid ester derivatives may be epoxidized fatty acid esters, or may be epoxidized and further derivatised fatty acid esters.

By epoxidized fatty acid ester, we mean the ester of an unsaturated fatty acid-based component with an epoxide group in place of a proportion or all of the carbon-carbon double bonds of the fatty acid upon which it is based.

By a curable composition, formulation or material, we mean a composition, formulation or material which may be caused to react such that chemical constituents present in the formulation become chemically bonded and larger chemical entities are formed. A curing reaction may be a cross-linking reaction, whereby chemical bonds are established between constituents of the formulation, optionally via a cross linker (a chemical species able to react with other constituents of the formulation at more than one position, but which, when taken alone, cannot be cured to form a cross-linked material) so as to form a disordered, extended, cross-linked network. For example, a polymeric, oligomeric or other high molecular weight material may be cross linked (with itself and/or another polymeric material and/or a cross linker). Polymerization is a further example of a curing reaction and may occur simultaneously with cross linking. By a cationically curable composition, formulation or material, we mean a curable composition, formulation or material which is curable by a chain reaction propagated, and typically also initiated, by the addition of cationic species to electron-rich function groups, to form a higher molecular weight cationic species. By thermally curable composition, formulation or material, we mean a curable composition, formulation or material which is curable by a chain reaction initiated by an elevation in temperature. The curing reaction of a thermally curable composition, formulation or material may take place above a temperature threshold and may cease (or the reaction rate be substantially decreased) below a temperature threshold (or when one or more reagents have been consumed). By photocurable, or radiation curable, composition, formulation or material, we mean a curable composition, formulation or material which is curable by a chain reaction initiated by incident light, or other radiation. The curing reaction of a photocurable, or radiation curable, composition, formulation or material may take place when light, or other radiation, is incident thereon, and may cease in the absence of such light, or other radiation (or when one or more reagents have been consumed).

Typically, all, or a substantial part of the formulation comprises resinous material, at least some of which is the resin.

By resin, or resinous material, we mean a material which, when taken alone or when mixed with one or more other resins, is curable, and which may be curable to form a cross-linked material. A resin may be a liquid or a solid at room temperature, containing a chemical compound, or compounds, all of which, or at least the substantial majority of which, reacts during curing to comprise a substantial proportion, by mass, of the cross-linked material.

By a substantial part of the cationically curable formulation, we mean preferably more than 50 wt %, or more than 60 wt % or more than 65 wt %. By a substantial part of the resin, we mean preferably more than 80 wt %, or more than 90 wt %, or more than 95 wt %. For example, a resin may comprise 80 wt %, or 90 wt %, or 95 wt % of a fatty acid ester, or derivative thereof, and smaller amounts of one or more impurities (as might be present in embodiments of the invention wherein the resin is obtained from natural materials such as one or more plant oils), or one or more additives (as may be required, in some embodiments, to adjust the rheology of the resin) which may or may not participate in a cationic curing reaction.

Known resin materials suitable to undergo a photoinitiated cationic curing reaction, and known curable epoxy resins, are of relatively high viscosity, typically of the order of several hundred centipoises (cP).

Reactive diluents are therefore conventionally added to formulations comprising known curable resins (for example, cationically curable epoxy resins) to reduce viscosity in order render them suitable for certain methods of application. For example, flexography requires the use of curable formulations with low viscosity, below approximately 65 cP, and may be less than 65 cP, and preferably less than 30 cP and for some applications in the region of 20-30 cP or less than 20 cP, and ink jet printing requires the use of curable formulations below 30 cP and in many cases lower than 10 cP or 5 cP.

A reactive diluent participates in the curing reaction and may terminate cross linking reactions or may function as a cross linker. However, unlike a resin, a reactive diluent is not, when taken alone or mixed with other non-resinous components, curable to form a cross-linked material. Therefore, if an excessive amount of reactive diluent is added to a formulation, the concentration of resin may be so low as to prevent a formulation from curing to form a cured, cross-linked material with acceptable properties. The minimum viscosity of known curable formulations is therefore limited by the amount of low viscosity reactive diluent which may be added to comparatively high viscosity resins.

A resin of the present invention (all, or a substantial part, of which comprises one or more fatty acid esters, or derivatives thereof, wherein each said fatty acid ester is not a mono-, di- or triglyceride) is of lower viscosity than known curable resins (for example, cationically curable epoxy resins) and may therefore be used to prepare cationically curable formulations having a lower viscosity than has been previously possible.

Thus, the formulation may be a low viscosity formulation, such as a coating formulation (having a viscosity preferably lower than 65 cP (or approximately 65 cP), and in some embodiments in the region of 20-30 cP). The formulation may be a flexographic coating formulation, suitable for flexographic printing applications, and which is curable to form a cross-linked coating. The formulation may be a liquid ink or varnish for packaging gravure or other liquid ink or varnish printing systems. In some embodiments the low viscosity formulation is an ink jet formulation, suitable for inkjet printing applications, and has a viscosity below 30 cP and in many cases lower than 10 cP or 5 cP, and which is curable to form a cross-linked coating.

By the viscosity of the (or any) resin, we refer to the viscosity which the resin would have at if it was pure, at NIST standard temperature and pressure (20° C., 101.325 kPa).

In embodiments comprising a plurality of fatty acid esters, or derivatives thereof, each said fatty acid ester, or derivative thereof, may be based on the same fatty acid, or on one or more different fatty acids. One or more, or all, of the or each said fatty acid ester, or derivative thereof, may be a fatty acid ester derivative. One or more, or all, of the or each said fatty acid ester, or derivative thereof, may be a fatty acid ester.

Preferably the or each said fatty acid ester, or derivative thereof, is based on a C:D fatty acid, where C is the fatty acid carbon chain length, D is the number of carbon-carbon double bonds in the fatty acid, D is from 0 to 4 and C is preferably at least 6 and may be from 6 to 24, or from 12 to 24, or from 12 to 22, or more preferably from 18 to 22.

Preferably the or each said fatty acid ester, or derivative thereof, comprises a C, hydrocarbon group on the ester oxygen, wherein n is from 1 to 4.

Preferably the or each said fatty acid ester, or derivative thereof, is an alkyl ester. Preferably the or each said alkyl ester, or derivative thereof, is a methyl, ethyl, propyl or butyl ester, and most preferably the or each ester is a methyl ester.

Fatty acid esters, or derivatives thereof, comprising a small hydrocarbon group on the ester oxygen, such as alkyl esters, and in particular methyl esters, typically have a lower viscosity than other fatty acid esters (or derivatives thereof). Therefore a cationically curable formulation having a given viscosity may be prepared having a minimum quantity of reactive, or passive, diluents. In some embodiments, the requirement for diluents may be removed entirely, and thus the formulations of the present invention may, in some embodiments comprise no reactive diluents and/or no passive diluents.

Preferably all, or a substantial part of the resin comprises (and in some embodiments consists of) the ester fraction of an esterified plant oil (which may be an epoxidized esterified plant oil), or derivative thereof, wherein the ester fraction does not comprise a mono-, di- or triglyceride (the ester fraction comprising one or more, or all of the or each said fatty acid ester, or derivative thereof).

A substantial portion of a plant oil may comprise a fatty acid-based component, such as a fatty acid mono-, di-, or triglyceride. A plant oil may comprise a mixture of fatty acid-based components. For example a plant oil may comprise a fatty acid triglyceride and smaller amounts of the mono- and/or diglycerides of the same fatty acid and/or the free fatty acid. A plant oil typically comprises a mixture of fatty acid-based components, based on more than one fatty acid, and typically comprises one or more mixed fatty acid-based components, such as mixed fatty acid mono-, di- and triglycerides.

Each said fatty-acid based component of a plant oil is chemically similar and behaves similarly in a number of common chemical reactions. Thus, an esterified plant oil may comprise a fatty acid ester of the or each fatty acid-based component present in the plant oil. Similarly a plant oil derivative may comprise a derivative of the or each fatty acid-based component present in the plant oil.

The ester fraction of an esterified plant oil, or derivative thereof, comprising esters of the or each fatty-acid based component present in the plant oil, or derivative thereof, is separable from other components of the esterified plant oil, or derivative thereof, including the reaction products of esterification, for example water and glycerol.

According to a second aspect of the invention there is provided a cationically curable formulation comprising a resin;

all, or a substantial part of the resin comprising the ester fraction of an esterified plant oil, or derivative thereof, the ester fraction comprising one or more fatty acid esters, or derivatives thereof, wherein the ester fraction does not comprise a mono-, di- or triglyceride.

The resin may be an epoxy resin. The formulation may be thermally curable or may be photocurable. Thus, the invention further extends to a curable (for example cationically photocurable or thermally curable) formulation comprising an epoxy resin; all, or a substantial part, of the resin comprising the ester fraction of an esterified epoxidized plant oil, or derivative thereof, the ester fraction comprising one or more epoxidized fatty acid esters, or derivatives thereof, wherein the ester fraction does not comprise a mono-, di- or triglyceride.

The resin may comprise small amounts of components of the plant oil, which have not reacted during esterification, such as mono-, di- and triglycerides of the fatty acid based components of the plant oil (or derivative thereof).

In some embodiments, the ester fraction of an esterified plant oil, or derivative thereof (which may be an esterified epoxidized plant oil), is an ester fraction of a purified plant oil.

The esterified plant oil derivative may be an epoxidized esterified plant oil, or the plant oil may be epoxidized and further derivatised.

By epoxidized plant oil, we mean a plant oil with an epoxide group in place of a proportion or all of the carbon-carbon double bonds of the or each unsaturated fatty acid-based component present in the plant oil upon which it is based.

In some instances, plant oils in their raw state contain a number of impurities which may be undesirable, for example due to their solubility. Plant oils may be purified by filtration and/or solvent extraction (wherein oil is typically washed with a common solvent such as an ether or hexane, in which the or each said fatty acid-based component has a high solubility) in order to decrease impurity levels and increase the proportion of fatty acid-based components of the oil.

In some embodiments, the resin comprises the ester fractions of one or more further esterified plant oils (which may be epoxidized esterified plant oils), or derivatives thereof. The resin may comprise an esterified plant oil blend, the blend comprising the ester fractions of two or more esterified plant oils (which may be epoxidized), or derivatives thereof. In some embodiments, the blend comprises the ester fraction of one or more plant oils, and one or more plant oil derivatives of the same or different plants.

We have observed that a curable formulation with a resin comprising the ester fractions of a plurality, or blend, of ester fractions of esterified plant oils, or derivatives thereof, or a plurality, or blend, of fatty acid esters, or derivatives thereof (in particular where the plurality of fatty acid esters are based upon a plurality of fatty acids) is less prone to crystallisation than curable formulations with a resin comprising the ester fraction of a single plant oil, or derivative thereof, or of formulations with a resin comprising a single fatty acid ester, or derivative thereof.

In some embodiments, the resin comprises at least one unsaturated fatty acid ester, or derivative thereof.

Preferably the or each said unsaturated fatty acid ester, is based on a C:D fatty acid, or derivative thereof, where C is the fatty acid carbon chain length, and is at least 6, D is the number of unsaturated functionalities in the fatty acid carbon chain, and D is between 1 and 4.

In some embodiments, each said fatty acid ester, or derivative thereof, is the ester of an epoxidized fatty acid ester, or derivative thereof. In some embodiments, each said ester fraction of an esterified plant oil, or derivative thereof, is the ester fraction of an epoxidized plant oil. Accordingly, the resin may be an epoxy resin.

Preferably the or each fatty acid ester, or derivative thereof, is based on a fatty acid selected from the group; caproic acid, caprylic acid, pelargonic acid, azelaic acid, capric acid, lauric acid, brassylic acid, myristic acid, palmitic acid, palmitoleic acid, stearic acid, dihydroxystearic acid, oleic acid, ricinoleic acid, linoleic acid, vernolic acid, dimorphecolic acid, densipolic acid, alpha linolenic acid, gamma linolenic acid, calendic acid, eleostearic acid, stearidonic acid, arachidic acid, gondoic acid, eicosenoic acid, gadolenic acid, lesquerolic acid, gadoleic acid, auricolic acid, behenic acid, erucic acid, docosadienoic acid, tetracosanoic acid and nervonic acid.

Preferably the or each esterified plant oil, or derivative thereof, is selected from the group; borage oil, calendula oil, camelina oil, castor oil, coconut oil, cotton seed oil, crambe oil, echium oil, hemp oil, jatropha oil, jojoba oil, lequerella oil, linseed oil, lunaria oil, meadowfoam oil, high erucic rape seed oil, rape seed oil, safflower oil, sunflower oil, soya oil, tall oil, tung oil, vernonia oil and walnut oil.

Preferably the or each esterified plant oil, or derivative thereof, is obtained from a plant crop which is not a food crop. Preferably the or each plant is suitable to be cultivated on marginal land (such as contaminated land or land having saline soil).

Thus, the invention extends to a curable formulation, wherein the or each esterified plant oil, or derivative thereof, is obtained from one or more plant crops grown on marginal land.

Preferably the curable formulation is a coatings formulation (for example an ink, varnish, or wood treatment formulation (which may be a cationically photocurable or thermally curable formulation) which is curable to form a cross-linked coating (for example an ink or varnish or wood treatment). In some embodiments, the curable formulation is an adhesive formulation, curable to form a cross-linked adhesive. The formulation may be a low-viscosity formulation such as a flexographic coatings formulation or an ink-jettable formulation, or may be suitable for gravure printing, any other method of printing liquid inks and varnishes. The formulation may be a flexographic formulation, suitable to be deposited on a substrate by the method of flexography. The formulation may be an ink-jettable formulation, suitable to be deposited on a substrate by inkjet printing.

Preferably, the formulation is photocurable, and curable to form a cross-linked material in response to radiation, for example light, such as ultraviolet (UV) light. The formulation may be electron beam curable, and curable to form a cross-linked material in response to an incident electron beam. The formulation may be a thermally curable formulation, and curable to form a cross-linked material in response to a rise in temperature.

Preferably, the formulation further comprises an initiator.

The initiator is present to initiate the curing process by reacting in response to a stimulus and may, or may not, function catalytically. The initiator may be any type of suitable initiator.

The initiator may be a radical initiator, a cationic initiator, or a hybrid initiator. The initiator may be a thermal initiator, which reacts so as to initiate curing in response to a rise in temperature, or the initiator may be a photoinitiator, which reacts so as to initiate curing in response to light, for example visible or ultraviolet light. In embodiments comprising a photoinitiator, the formulation may further comprise a photosensitiser. Photosensitisers are compounds added to the formulation to modify the absorption spectrum of the photoinitiator so as to increase the efficiency with which it absorbs radiant energy. A curable formulation comprising a photoinitiator may be a photo-curable formulation (such as a UV-curable formulation).

In some embodiments the initiator is a thermal radical initiator, which may be a peroxide compound of the general formula RO—OR, such as benzoyl peroxide (CAS No. 94-36-0) or di-tertiary butyl peroxide (CAS No. 110-05-4), or may be an azo compound of the general formula RN═NR, such as azobisisobutyronitrile (CAS No. 78-67-1). Thermal radical initiators typically fragment when heated to form short-lived radical species (for example peroxides form RO., where R is a general hydrocarbon group) which react with carbon-carbon double bonds according to the general reaction scheme (1), but are also known to react with epoxide groups according to the general reaction scheme (2) (such as those present, for example, in epoxidized plant oils and epoxidized fatty acid-based components) and may react with other chemical groups.

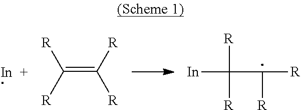

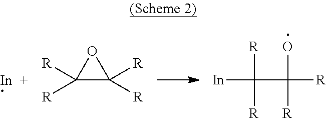

Where In is an initiator radical, such as a peroxide radical, formed from the thermal radical initiator by heating, and R are hydrocarbon substituents (including H), which may be the same or different.

In some embodiments the initiator is a redox initiator, comprising a redox pair of compounds.

In some embodiments, the initiator is a radical photoinitiator such as benzophenone (CAS No. 119-61-9) or a benzophenone derivative (for example phenylbenzophenone, CAS No. 2128-93-0) or acetophenone (CAS No. 98-86-2), or an acetophenone derivative (for example 2,2-diethoxyacetophenone, CAS No. 6175-45-7) or benzoin methyl ether (CAS No. 3524-62-7), or a benzoin ether derivative, or any other suitable radical photoinitiator.

Typically, formulations comprising a radical photoinitiator further comprise a synergist, such as an amine (for example, a tertiary amine of the general formula (RCH₂)₃N), or a tertiary α-amine alcohol of the general formula RCH(OH)CH₂NR₂), wherein, in use, the radical photoinitiator is excited by light radiation and the resulting excited photoinitiator (which may be a radical species) reacts with the synergist to produce one or more radical species able to initiate a curing reaction, in the manner of scheme (1) or scheme (2).

The initiator may be a cationic initiator, which may be a cationic photoinitiator or a cationic thermal initiator.

A cationic initiator is present to initiate the curing process by reacting to form a cationic species, or a cation donor species, in response to a stimulus and may, or may not, function catalytically. Preferably, the initiator is a cationic photoinitiator, which reacts so as to initiate curing in response to light, for example visible or, more preferably, ultraviolet light. In embodiments comprising a cationic photoinitiator, the formulation may further comprise a photosensitiser.

Cationic initiators are particularly suitable to initiate the curing reaction of formulations comprising one or more epoxidized fatty acid esters, or derivatives thereof, or the ester fractions of one or more epoxidized plant oils, or derivatives thereof. In use, a cationic photoinitiator absorbs light radiation (or heat) to form a cation-donor species, or a cationic species, able to react with an epoxidized fatty acid-based component according to the general scheme (3) or (4) (for cationic initiators which react to form a cation-donor species, or a cationic species, respectively), to initiate the curing reaction. A cationic photoinitiator, such as an aryl sulphonium salt (for example the mixed triarylsulphonium hexafluoroantimonate salts, CAS No. 109037-75-4, Cyracure product number UVI-6976, available from the Dow Chemical Company, or the mixed triarylsulphonium hexafluorophosphate salts, CAS No. 109037-77-6, Cyracure product number UVI-6992, available from the Dow Chemical Company) may, in use, absorb light radiation to form (in some cases by decomposition) a “super acid”. The super acid species reacts to form intermediates by addition to the epoxide oxygen atoms of epoxidized fatty acid-based materials, for example according to the general scheme (3):

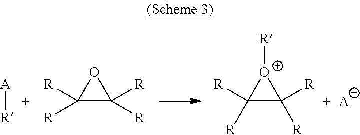

Where A-R′ is the cation-donor species formed by absorption of light radiation by a cationic initiator, and wherein, in some embodiments, R′ is a hydrocarbon or a proton, and R are hydrocarbon groups, which may include H and which may be the same or different.

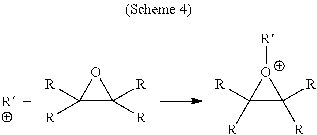

Where R′^{⊕} is the cationic species, or the cationic fragment of a cation-donor species, formed by absorption of light radiation by a cationic initiator, and wherein, in some embodiments, R is a hydrocarbon or a proton, and R are hydrocarbon groups, which may include H and which may be the same or different.

Some cationic initiators, for example 4,4′-dimethyl-diphenyl-iodonium hexafluorophosphate (available from IGM Resins Ltd., under the product name Omnicat 440) may function as either a photoinitiator or a thermal initiator, by formation of a superacid species in response to light or heat.

The thermal cationic initiator may be, or comprise, a metal salt, which initiates the curing reaction by acting as a Lewis acid and binding to electron rich moeties such as epoxide oxygens. For example, suitable thermal cationic initiators include fatty acid metal salts (which can be mixed salts), for example cobalt tallate (a cobalt (II) salt obtained from tall oil).

Optionally, the formulation comprises an initiator solvent. It is a known problem of some cationic initiators, in particular cationic photoinitiators such as arylsulfonium salts, to suffer from low solubility in the resins of cationically curable formulations, and to therefore require the presence of a solvent (for example propylene carbonate, CAS No. 108-32-7).

Typically, in formulations comprising an initiator (such as a cationic initiator), the formulation comprises in the region 2% to 8% by weight of initiator, and more typically in the region of 4% to 6% by weight of initiator. In the absence of an initiator solvent, the limit of solubility of initiators, such as arylsulphonium salts, in known curable formulations is typically in the range of 3%-5% by weight. Initiator solvent is typically a passive component of the system and is evaporated by heating before (and in some instances during or after) curing.

We have observed that the solubility of such photoinitiators in some embodiments of the present invention comprising an initiator (in particular, formulations comprising a blend of fatty acid esters, or derivatives thereof, or curable formulations comprising the ester fractions of a blend of esterified plant oils, or derivatives thereof) is higher, and in some cases considerably higher, than the solubility of the initiators (for example, the cationic photoinitiators) in known curable formulations. Accordingly, it is an advantage of such blended formulations that less initiator solvent, or no initiator solvent, is required. Thus, it may be that curable formulations according to some embodiments of the invention do not comprise an initiator solvent.

In some embodiments, the formulation further comprises one or more reactive modifiers. One or more reactive modifiers may be added to a formulation to modify the properties of the cured cross-linked material, such as surface adhesion, hardness or flexibility. Reactive modifiers participate in the curing reaction and may terminate cross linking reactions or may function as cross linkers. However, unlike resins, reactive modifiers when taken alone, are not curable, or curable to form a cross-linked material.

Each said reactive modifier may, for example, be a polyol (such as ethylene glycol, glycerol, or sugars such as glucose, or dendritic polyester polyols) or a small molecule epoxide, such as limonene oxide, CAS No. 1195-92-2, limonene dioxide, CAS No. 96082 (which may function as a cross linker), or a substance containing limonene oxide or limonene dioxide (for example epoxidized lemon oil) or cyclohexene oxide, CAS No. 286-20-4, or a strained heterocycle such as 3,3-dimethyloxetane, CAS No. 6921-35-3, or trimethylpropane oxetane (TMPO), CAS No. 3047-32-2, or a terpenoid such as abietic acid, CAS No. 514-10-3, or a terpenoid containing material such as pine rosin. Reactive modifiers of this type are particularly suitable for curable formulations comprising an epoxidized fatty acid-based component, or an epoxidized plant oil, or derivative thereof.

In some embodiments the formulation may further comprise one or more passive modifiers. One or more reactive modifiers may be added to a formulation to modify the properties of the formulation or of the cured cross-linked material. A passive modifier does not participate in the curing reaction and may, for example, function as a plasticizer, or as a dispersant, or a surfactant or a rheology modifier.

In some embodiments the formulation comprises one or more pigments. The formulation may comprise any suitable pigment, which may be an organic pigment, a metal organic pigment or an inorganic pigment or a combination of pigments. Suitable organic pigments include, for example, diarylide pigments such as benzidine, CAS No. 92-87-5, or benzimidazole pigments such as 4-methylbenzimidazolone, CAS No. 19190-68-2, or dioxazine pigments such as carbazole dioxazine, CAS No. 65381-32-0. Suitable organometallic pigments include, for example, phthalocyanine pigments such as copper (II) phthalocyanine, CAS No. 147-14-8. Suitable inorganic pigments include, for example, titanium dioxide, or amorphous carbon (also known as “carbon black”), or hexacyanoferrate (Prussian blue), CAS No. 14038-43-8.

Optionally, the formulation further comprises a pigment carrier. Pigment is present in the formulation as a dispersed solid and is therefore typically ground together with a suitable liquid medium, in order that the pigment is dispersed in the liquid medium, prior to mixing the liquid medium with the other components of the formulation, thereby enabling the pigment to be dispersed in the formulation. Suitable pigment carriers include, for example, a portion of the resin thickened by the dissolution of pine rosin (the major component of which is abietic acid), pine rosin, or a dendritic polyester alcohol.

The pigment carrier may be a resinous material, such as a co-resin, which may be comprise (or consist of) one or more fatty acid-based components, or derivatives thereof, or one or more plant oils, or derivatives thereof. Typically, pigment is dispersed in the pigment carrier by a high-shear mixing process, to produce an ink concentrate, and the pigment carrier is preferably a relatively high viscosity material (i.e. typically having a viscosity which is a factor of three, or four, or more, of the viscosity of the curable formulation), in order that high shear forces sufficient to disperse the pigment, may be generated.

The formulation may be a curable ink formulation, comprising a pigment dispersed therein.

Preferably, the formulation further comprises a co-resin. In some embodiments, the co-resin has a different viscosity to the resin. Typically a co-resin has a higher viscosity than the resin, such that the viscosity of a formulation may be adjusted by adjusting the relative proportions of the resin and the co-resin. A formulation comprising a resin and a co-resin is curable to form a cross-linked material, having chemical cross linking between constituents of the resin, between constituents of the co-resin, and between constituents of the resin and co-resin.

In embodiments comprising a pigment, the co-resin, or a portion of the co-resin, may be suitable for, and may be used as, a pigment carrier. For example, a pigment may be dispersed during a high shear mixing process within a high viscosity co-resin.

The co-resin may be any suitable curable resin material. In some embodiments, the co-resin is a synthetic co-resin, or comprises a synthetic co-resin material, such as a synthetic di-epoxide. The co-resin may comprise a synthetic cycloaliphatic di-epoxide such as Cyracure resins 6110. 6107 and 6105 (the major constituent of which is 3,4-epoxy cyclohexyl methyl-3,4 epoxy cyclohexane carboxylate), or may comprise a compound with one or more heterocyclic functional groups, such as lactones or an oxetanes, or a compound comprising one or more a vinyl ether functional groups.

Preferably, all or a substantial portion of the co-resin comprises (or, in some embodiments, consists of) at least one fatty acid-based component, wherein the fatty acid-based component is a fatty acid mono-, di- or triglyceride, or derivative thereof. One or more of the or each fatty acid-based component may be based on the same fatty acid, or each said fatty acid-based component may be based on different fatty acids.

A fatty acid-based component is chemically similar to the fatty acid ester, or derivative thereof, of the resin and therefore reacts similarly in a number of chemical reactions, including a curing reaction, to the fatty acid ester, or derivative thereof. Thus, the relative proportions of the resin and the or each said co-resin comprising at least one fatty acid-based component may be adjusted without significantly affecting the rate and extent of a curing reaction of the formulation. Therefore, as properties of the cured, cross-linked material such as surface adhesion, hardness and flexibility depend on the rate and extent of the curing reaction, provision of a co-resin comprising a fatty acid-based component enables the viscosity of the formulation to be adjusted whilst having less effect on the properties of the cured, cross-linked material obtained from the formulation, than from the use of alternative co-resins, or diluents. The use of a viscous co-resin comprising at least one fatty acid-based component as a pigment carrier (in embodiments comprising a pigment) obviates the requirement to include thickening agents such as pine rosin, or non-resinous pigment carriers such as dendritic polyols.

The invention therefore extends to an ink concentrate for a curable ink formulation; the formulation comprising a resin (typically an epoxy resin), a pigment carrier and a pigment;

all, or a substantial part, of the resin comprising the ester fraction of an esterified plant oil (typically an epoxidized esterified plant oil), or derivative thereof, the ester fraction comprising one or more epoxidized fatty acid esters, or derivatives thereof, wherein each said fatty acid ester is not a mono-, di- or triglyceride;
the ink concentrate comprising a pigment dispersed in a pigment carrier, the pigment carrier having a higher viscosity than the resin, all or a substantial part of the pigment carrier comprising an epoxidized plant oil, or derivative thereof.

The invention therefore extends to an ink concentrate for mixing with a curable formulation comprising (or consisting of) a resin (typically an epoxy resin), all, or a substantial part, of the resin comprising the ester fraction of an esterified plant oil (typically an epoxidized esterified plant oil), or derivative thereof, the ester fraction comprising one or more fatty acid esters (typically epoxidized fatty acid esters), or derivatives thereof, wherein each said fatty acid ester is not a mono-, di- or triglyceride; to form a curable ink formulation;

the ink concentrate comprising a pigment dispersed in a pigment carrier (which is typically of higher viscosity than the formulation or resin with which the concentrate is to be mixed, in use), all or a substantial part of the pigment carrier comprising an epoxidized plant oil, or derivative thereof.

The curable ink formulation may comprise a co-resin, all or a substantial portion of the co-resin comprising an epoxidized plant oil, or derivative thereof and the pigment carrier may be a portion of the co-resin.

Thus the ink concentrate may be for mixing with an epoxy resin and an epoxy co-resin to form a curable ink formulation; the ink concentrate comprising a pigment dispersed in a portion of the co-resin, all or a substantial portion of the co-resin comprising an epoxidized plant oil, or derivative thereof.

The invention also extends to a kit for a curable ink formulation, comprising an ink concentrate and a curable resin formulation;

the curable formulation comprising an epoxy resin, all, or a substantial part, of the resin comprising the ester fraction of an epoxidized esterified plant oil, or derivative thereof, the ester fraction comprising one or more epoxidized fatty acid esters, or derivatives thereof, wherein each said fatty acid ester is not a mono-, di- or triglyceride;
the ink concentrate comprising a pigment dispersed in a pigment carrier, the pigment carrier having a higher viscosity than the resin, all or a substantial part of the pigment carrier comprising an epoxidized plant oil, or derivative thereof.

The kit may further comprise second curable resin formulation, the second curable resin formulation comprising (or consisting of) an epoxy co-resin, all or a substantial portion of the co-resin comprising an epoxidized plant oil, or derivative thereof, and the pigment carrier may be a portion of the co-resin.

The or each said fatty acid-based component, may be a mixed fatty acid-based component (by which we mean a fatty acid-based component, based on more than one fatty acid, or derivative thereof, for example a mixed fatty acid di- or triglyceride), or the or each said fatty acid-based component, may be a fatty acid-based component of a single fatty acid, or derivative thereof.

Preferably the or each said fatty acid-based component, is based on a C:D fatty acid, or derivative thereof, where C is the fatty acid carbon chain length, D is the number of carbon-carbon double bonds in the fatty acid, D is from 0 to 4 and C is preferably at least 6 and may be from 6 to 24, or from 12 to 24, or from 12 to 22, or more preferably from 18 to 22.

Preferably all, or a substantial part of the co-resin comprises (or, in some embodiments, consists of) a plant oil, or derivative thereof, which comprises the, or a plurality of, or all of, the or each said fatty acid-based component. The co-resin may be an epoxy resin and may, for example, comprise or consist of an epoxidized plant oil, or derivative thereof.

A substantial portion of a plant oil may comprise a fatty acid-based component, such as a fatty acid triglyceride. A plant oil may comprise a mixture of fatty acid-based components. For example a plant oil may comprise a fatty acid triglyceride and smaller amounts of the mono- and/or diglycerides of the same fatty acid and/or the free fatty acid. A plant oil typically comprises a mixture of fatty acid-based components, based on more than one fatty acid, and typically comprises one or more mixed fatty acid-based components.

Each said fatty-acid based component of a plant oil is chemically similar and behaves similarly in a number of common chemical reactions. Thus, a plant oil derivative may comprise a derivative of the or each fatty acid-based component present in the plant oil.

In some embodiments, one or more of the or each fatty acid-based component (of the co-resin) is based on the same fatty acid or acids as one or more of the fatty acid esters of the resin.

In some embodiments, the ester fraction of an esterified plant oil, or derivative thereof, of the resin, is an ester fraction of an esterified oil of the same plant as the plant oil, or derivative thereof, of the co-resin. In some embodiments, the ester fraction of an esterified plant oil, or derivative thereof, of the resin, is an ester fraction of an esterified oil of a different plant as the plant oil, or derivative thereof, of the co-resin.

Plant oils are natural products and the precise composition and physical properties, such as viscosity, of a given plant oil variety may vary depending on its source. The provision of a plant oil based or fatty acid based co-resin (typically having a higher viscosity than the resin) enables the viscosity of the formulation to be adjusted by adjusting the relative proportions of the resin and co-resin, whilst having a minimal effect on the properties, other than the viscosity, of the formulation and of the resulting cross-linked material, is advantageous since a formulation with a predetermined viscosity to be prepared, regardless of the precise viscosity of the plant oils from which it has been derived and, despite variations in the properties of the raw materials, a product with consistent properties may be produced.

The co-resin may comprise a blend of plant oils, or derivatives thereof.

We have observed that a curable formulation with a co-resin comprising a plurality, or blend, of fatty acid based components, or derivatives thereof (in particular where the plurality of fatty acid based components are based upon a plurality of fatty acids), or comprising a plurality or blend of plant oils, or derivatives thereof, is less prone to crystallisation than curable formulations with a co-resin comprising a single fatty-acid based component, or derivative thereof, or a single plant oil, or derivative thereof (as the case may be). We have also observed that the solubility of certain components (for example initiators) is greater in such blended compositions.

The esterified plant oils, or derivatives thereof, of the resin, and none, one, or more, or all of the plant oils, or derivatives thereof, of the co-resin, may be oils of the same plants.

In some embodiments, the esterified plant oil blend, or derivative thereof, of the resin, and the plant oil blend, or derivative thereof, of the co-resin are blends of oils of the same plants, which may be blended in similar, or the same, proportions. Thus, a greater degree of chemical similarity between the resin and the co-resin may be provided, such that variations in the relative proportions of the resin and co-resin will have a minimal effect on the properties of the formulation, other than viscosity, or of the cured, cross-linked material obtained therefrom.

Preferably the co-resin comprises at least one unsaturated fatty acid-based component.

Preferably the or each said unsaturated fatty acid-based component is based on a C:D fatty acid, or derivative thereof, where C is the fatty acid carbon chain length, and is at least 6, D is the number of unsaturated functionalities in the fatty acid carbon chain, and D is between 1 and 4.

Preferably, the or each said fatty acid derivative-based component is an epoxidized fatty acid-based component.

By epoxidized fatty acid-based component, we mean an unsaturated fatty acid-based component with an epoxide group in place of a proportion or all of the carbon-carbon double bonds of the fatty acid upon which it is based.

In some embodiments, the or each said plant oil derivative is an epoxidized plant oil, or derivative thereof.

By epoxidized plant oil, we mean a plant oil with an epoxide group in place of a proportion or all of the carbon-carbon double bonds of the or each unsaturated fatty acid-based component present in the plant oil upon which it is based.

Preferably the or each fatty acid-based component is based on a fatty acid selected from the group; caproic acid, caprylic acid, pelargonic acid, azelaic acid, capric acid, lauric acid, brassylic acid, myristic acid, palmitic acid, palmitoleic acid, stearic acid, dihydroxystearic acid, oleic acid, ricinoleic acid, linoleic acid, vernolic acid, dimorphecolic acid, densipolic acid, alpha linolenic acid, gamma linolenic acid, calendic acid, eleostearic acid, stearidonic acid, arachidic acid, gondoic acid, eicosenoic acid, gadolenic acid, lesquerolic acid, gadoleic acid, auricolic acid, behenic acid, erucic acid, docosadienoic acid, tetracosanoic acid and nervonic acid.

Preferably the or each plant oil, or derivative thereof, is selected from the group; borage oil, calendula oil, camelina oil, castor oil, coconut oil, cotton seed oil, crambe oil, echium oil, hemp oil, jatropha oil, jojoba oil, lequerella oil, linseed oil, lunaria oil, meadowfoam oil, high erucic rape seed oil, rape seed oil, safflower oil, sunflower oil, soya oil, tall oil, tung oil, vernonia oil and walnut oil.

Preferably the or each plant oil, or derivative thereof, is obtained from a plant crop which is not a food crop. Preferably the or each plant is suitable to be cultivated on marginal land (such as contaminated land or land having saline soil). Thus, the invention extends to a curable formulation, wherein the or each plant oil, or derivative thereof, or the or each esterified plant oil, or derivative thereof, is obtained from one or more plant crops grown on marginal land.

According to a third aspect of the invention there is provided a curable formulation comprising a first resin and a second resin;

the first resin having a first viscosity and the second resin having a second viscosity that is less than the first viscosity;
the first resin comprising a first fatty acid-based component, wherein the fatty acid-based component is a fatty acid, fatty acid mono-, di-, or triglyceride, or derivative thereof;
and the second resin comprising a fatty acid ester of a second fatty acid-based component, wherein the fatty acid ester is not a mono-, di- or triglyceride.

In some embodiments, the first fatty acid-based component is based on the same fatty acid as the second fatty acid based component. In some embodiments, the first and second fatty acid-based components are the same fatty acid-based component.

According to a fourth aspect of the invention, there is provided to a curable formulation comprising a first resin and a second resin;

the first resin having a first viscosity and the second resin having a second viscosity that is less than the first viscosity;
the first resin comprising a fatty acid-based component, wherein the fatty acid-based component is a fatty acid, fatty acid mono-, di-, or triglyceride, or derivative thereof;
and the second resin comprising a fatty acid ester of the fatty acid-based component, wherein the fatty acid ester is not a mono-, di- or triglyceride.

Preferably the second viscosity is less than half of the first viscosity, or less than a third, or less than a quarter, or less than one sixth. In some embodiments, the second viscosity has a magnitude of less than 10% of the first viscosity, or less than 5% or less than 1%. The viscosity of the resin (of the first and second aspects) may be less than half of the viscosity of the co-resin, or less than a third, or less than a quarter, or less than one sixth. In some embodiments, the viscosity of the resin has a magnitude of less than 10% of the first viscosity, or less than 5% or less than 1% of the viscosity of the co-resin.

Preferred and optional features of the first and second resins of the third and fourth aspects correspond to preferred and optional features of the co-resin and resin, respectively, of the first and second aspects. Further preferred and optional features of the third and fourth aspects correspond to preferred and optional features of the first and second aspects.

According to a fifth aspect of the invention there is provided a cross-linked material comprising a cationically cured resin;

the cross-linked material having chemical cross linking between constituents resin;
all, or a substantial part, of the resin comprising one or more fatty acid esters, or derivatives thereof, wherein each said fatty acid ester is not a mono-, di- or triglyceride.

All, or a substantial part, of the resin may be the ester fraction of an esterified plant oil.

The resin may be an epoxy resin. In some embodiments, the cross-linked material is thermally cured, or may be photocured. The invention thus extends in a further aspect to a cross linked material comprising a cured (for example cationically photocured or thermally cured) epoxy resin; the cross-linked material having chemical cross linking between constituents resin; all, or a substantial part, of the resin comprising one or more epoxidized fatty acid esters, or derivatives thereof, wherein each said epoxidized fatty acid ester is not a mono-, di- or triglyceride.

The fatty acid ester derivatives may be epoxidized fatty acid esters, or may be epoxidized and further derivatised fatty acid esters.

In embodiments wherein the resin comprises a plurality of fatty acid esters, or derivatives thereof, each said fatty acid ester, or derivative thereof, may be based on the same fatty acid, or on one or more different fatty acids. One or more, or all, of the or each said fatty acid ester, or derivative thereof, may be a fatty acid ester derivative. One or more, or all, of the or each said fatty acid ester, or derivative thereof, may be a fatty acid ester.

Preferably the or each said fatty acid ester comprises a C, hydrocarbon group on the ester oxygen, wherein n is from 1 to 4.

Preferably the or each fatty acid ester, is an alkyl ester. Preferably the or each alkyl ester is a methyl, ethyl, propyl or butyl ester, and most preferably the or each ester is a methyl ester.

Preferably, each said fatty acid ester derivative is an epoxidized fatty acid ester, or derivative thereof.

In some embodiments, the cross-linked material comprises a cured (for example cationically photocured or thermally cured) mixture of a resin and a co-resin (which may be epoxy resins);

the cross-linked material having chemical cross linking between constituents of the resin, between constituents of the co-resin, and between constituents of the resin and co-resin.

Preferably the uncured resin and co-resin have different viscosities.

The co-resin may be any suitable curable resin material.

Further preferred and optional features of the resin and co-resin of the cross-linked material correspond to preferred and optional features of the resin and co-resin of the curable formulations of the first and second aspects.

According to a sixth aspect of the invention there is provided a cross-linked material comprising a cured mixture of a first resin and a second resin;

the cross-linked material having chemical cross linking between constituents of the first resin, between constituents of the second resin, and between constituents of the first and second resins;
the uncured first resin having a first viscosity and the uncured second resin having a second viscosity that is less than the first viscosity;
the first resin comprising a first fatty acid-based component, wherein the fatty acid-based component is a fatty acid, fatty acid mono-, di-, or triglyceride, or derivative thereof;
the second resin comprising a fatty acid ester of a second fatty acid-based component, wherein the fatty acid ester is not a mono-, di- or triglyceride.

In some embodiments, the first fatty acid-based component is based on the same fatty acid as the second fatty acid based component. In some embodiments, the first and second fatty acid-based components are the same fatty acid-based component.

Accordingly, the invention extends in a further aspect to a cross-linked material comprising a cured mixture of a first resin and a second resin;

the cross-linked material having chemical cross linking between constituents of the first resin, between constituents of the second resin, and between constituents of the first and second resins;
the uncured first resin having a first viscosity and the uncured second resin having a second viscosity that is less than the first viscosity;
the first resin comprising a fatty acid-based component, wherein the fatty acid-based component is a fatty acid, fatty acid mono-, di-, or triglyceride, or derivative thereof;
the second resin comprising a fatty acid ester of the fatty acid-based component, wherein the fatty acid ester is not a mono-, di- or triglyceride.

According to a seventh aspect of the invention there is provided a cross-linked material comprising a cured mixture of a first resin and a second resin;

the cross-linked material having chemical cross linking between constituents of the first resin, between constituents of the second resin, and between constituents of the first and second resins;
the uncured first resin having a first viscosity and the uncured second resin having a second viscosity that is less than the first viscosity;
the first resin comprising a first plant oil, or derivative thereof, having at least one first fatty acid-based component, wherein each said fatty acid-based component is a fatty acid, fatty acid mono-, di-, or triglyceride, or derivative thereof;
and the second resin comprising the ester fraction of an esterified second plant oil, or derivative thereof, having at least one second fatty acid-based component, wherein the ester fraction does not comprise a mono-, di- or triglyceride.

In some embodiments, the first plant oil, or derivative thereof, is a purified first plant oil, or derivative thereof. In some embodiments, the ester fraction of an esterified second plant oil, or derivative thereof, is an ester fraction of a purified second plant oil.

In some embodiments, the first resin comprises one or more further first plant oils, or derivatives thereof. The first resin may comprise a plant oil blend comprising two or more plant oils, or derivatives thereof. In some embodiments, the blend comprises one or more plant oils, and one or more plant oil derivatives of the same or different plants.

In some embodiments, the second resin comprises the ester fractions of one or more further esterified second plant oils, or derivatives thereof. The second resin may comprise an esterified plant oil blend, the blend comprising the ester fractions of two or more plant oils, or derivatives thereof. In some embodiments, the blend comprises the ester fraction of one or more plant oils, and one or more plant oil derivatives of the same or different plants.

The esterified second plant oils, or derivatives thereof, and none, one, or more, or all of the first plant oils, or derivatives thereof, may be oils of the same plant.

In some embodiments, the esterified plant oil blend, or derivative thereof, of the second resin, and the plant oil blend, or derivative thereof, of the first resin are blends of oils of the same plants, which may be blended in similar, or the same, proportions.

Preferred and optional features of the first resin and second resin (of the sixth and seventh aspects) correspond to preferred and optional features of the co-resin and resin of the fifth aspect.

The cross-linked material may further comprise one or more reactive modifiers, which may be chemically bound to components of the resin and/or the co-resin (where present). The cross-linked material may comprise a reactive modifier which may be a chemical cross-linker between components of the resin, between components of the co-resin (where present), and between components of the resin and co-resin (where a co-resin is present).

The cross-linked material may further comprise one or more passive modifiers and/or one or more pigments and/or one or more pigment carriers, preferred and optional features of which correspond to preferred and optional features of the first aspect.

Preferred and optional features of the of the cross linked material (of the fifth through seventh aspects) correspond to preferred and optional features of the curable formulation (of the first through fourth aspects).

By a derivative of a chemical entity, we mean a chemical entity sharing substantially the same carbon backbone as the chemical entity, but having up to one, two or three deletions, substitutions or additions of functional groups present on the carbon backbone.

For example, an unsaturated fatty acid-based component derivative may be an epoxidized fatty acid-based component, wherein epoxide groups are present in place of a proportion of, or all of, the carbon-carbon double bonds of the corresponding unsaturated fatty acid-based component. Alternatively, or in addition, an unsaturated fatty acid-based component derivative may, for example, be a hydroxylated fatty acid-based component, wherein the chemical unit —CH—C(OH)— is present in place of a proportion of, or all of, the carbon-carbon double bonds of the corresponding unsaturated fatty acid-based component.

Similarly, a plant oil derivative may be an epoxidized plant oil, wherein epoxide groups are present in the place of a proportion of, or all of, the carbon-carbon double bonds of any unsaturated fatty-acid based components present in the plant oil. Alternatively, for example, a plant oil derivative may be a partially or fully hydroxylated plant oil, wherein the chemical unit —CH—C(OH)— is present in place of a proportion of, or all of, the carbon-carbon double bonds of unsaturated fatty acid-based components present in the plant oil.

By superacid, we mean a compound having an acidity greater than the acidity of 100 wt % sulphuric acid.

By reactive, or active, components of the curable formulation, we mean components which participate in the curing reaction, for example with the first and/or second resins. Unlike a resin, a reactive, or active, component of a curable formulation is not, when taken alone or mixed with other non-resinous components, curable to form a cross-linked material.

By passive components of the curable formulation, we mean components which do not participate in the curing reaction and which therefore remain permanently within the resulting cross-linked material, or which evaporate over time.

According to an eighth aspect of the present invention there is provided a method of preparing a cationically curable formulation, comprising the step of;

providing a resin, all, or a substantial part of which comprises one or more fatty acid esters, or derivatives thereof, wherein each said fatty acid ester is not a mono-, di- or triglyceride.

The resin may be an epoxy resin. In some embodiments, the formulation is thermally curable and may be photocurable. The invention thus extends in a further aspect to a method of preparing a curable formulation (for example cationically photocurable or thermally curable), comprising the step of providing an epoxy resin; all, or a substantial part, of the resin comprising one or more epoxidized fatty acid esters, or derivatives thereof, wherein each said epoxidized fatty acid ester is not a mono-, di- or triglyceride.

In some embodiments, the method comprises the step of providing a co-resin (such as an epoxy co-resin) and may comprise the step of mixing the resin and a co-resin. The method may comprise the step, or steps, of providing one or more fatty acid esters, or derivatives thereof, and thereby providing a resin.

In embodiments wherein a resin is provided comprising a plurality of fatty acid esters, or derivatives thereof, each said fatty acid ester, or derivative thereof, may be based on the same fatty acid, or on one or more different fatty acids. One or more, or all, of the or each said fatty acid ester, or derivative thereof, may be a fatty acid ester derivative. One or more, or all, of the or each said fatty acid ester, or derivative thereof, may be a fatty acid ester.

Preferably the or each said fatty acid ester, or derivative thereof, is based on a C:D fatty acid, where C is the fatty acid carbon chain length, D is the number of carbon-carbon double bonds in the fatty acid, D is from 0 to 4 and C is preferably at least 6 and may be from 6 to 24, or from 12 to 24, or from 12 to 22, or more preferably from 18 to 22.

Preferably the or each said fatty acid ester, or derivative thereof, comprises a C, hydrocarbon group on the ester oxygen, wherein n is from 1 to 4.

Preferably the or each said fatty acid ester, or derivative thereof, is an alkyl ester. Preferably the or each said alkyl ester, or derivative thereof, is a methyl, ethyl, propyl or butyl ester, and most preferably the or each ester is a methyl ester.

Preferably the method comprises the step of providing the ester fraction of an esterified plant oil (or, in some embodiments, an epoxidized esterified plant oil), or derivative thereof (the ester fraction comprising the, or a plurality, or all, of the or each said fatty acid ester, or derivative thereof), wherein the ester fraction does not comprise a mono-, di- or triglyceride, and thereby providing all, or a substantial part, of the resin.

All, or a substantial part of the co-resin may comprise (or consist of) one or more fatty acid-based components, wherein each said fatty acid-based component is a fatty acid mono-, di- or triglyceride, or derivative thereof. One or more of the or each fatty acid-based component may be based on the same fatty acid, or each said fatty acid-based component may be based on different fatty acids.

Preferably all, or a substantial part of the co-resin comprises (or, in some embodiments, consists of) a plant oil (which may be an epoxidized plant oil), or derivative thereof.

Typically a co-resin has a higher viscosity than the resin, such that the viscosity of a formulation may be adjusted by adjusting the relative proportions of the resin and the co-resin.

The method may comprise the step of providing an epoxy co-resin having a higher viscosity than the resin; all or a substantial portion of the co-resin comprising an epoxidized plant oil, or derivative thereof; dispersing the pigment in a proportion or all of the co-resin (for example by milling, or high-shear mixing) to thereby form an ink concentrate, and mixing the ink concentrate with the formulation (or the resin), to thereby provide a curable ink formulation.

The invention extends to a method of preparing an ink concentrate for a mixing with a curable formulation comprising an epoxy resin all, or a substantial part, of the resin comprising the ester fraction of an epoxidized esterified plant oil, or derivative thereof, the ester fraction comprising one or more epoxidized fatty acid esters, or derivatives thereof, wherein each said fatty acid ester is not a mono-, di- or triglyceride; to form a curable ink formulation;

comprising dispersing a pigment in a pigment carrier (typically having a higher viscosity than the formulation in which the concentrate is intended to be used); all or a substantial part of the pigment carrier comprising an epoxidized plant oil, or derivative thereof.

The method may comprise mixing said ink concentrate with a said resin to thereby prepare a cationically curable ink formulation.

Plant oils are natural products and the precise composition and physical properties, such as viscosity, of a given plant oil variety may vary depending on its source. The provision of a plant oil based (or fatty acid based) co-resin (typically having a higher viscosity than the resin) enables the viscosity of the formulation to be adjusted by adjusting the relative proportions of the resin and co-resin, whilst having a minimal effect on the properties, other than the viscosity, of the formulation and of the resulting cross-linked material, is advantageous since a formulation with a predetermined viscosity to be prepared, regardless of the precise viscosity of the plant oils from which it has been derived and, despite variations in the properties of the raw materials, a product with consistent properties may be produced.

Thus the invention extends in a further aspect to a method of preparing a curable formulation, of a predetermined viscosity, comprising the steps of providing a resin having a first viscosity, all or a substantial portion of the resin comprising (or consisting of) the ester fraction of an esterified plant oil, wherein the ester fraction does not comprise a mono-, di- or triglyceride;

providing a co-resin resin having a second viscosity which is higher than the first viscosity, all or a substantial portion of the co-resin comprising (or consisting of) a plant oil, or derivative thereof; and
mixing the first resin and the second resin in the proportions required to produce a curable formulation having a predetermined viscosity having a value between the first viscosity and second viscosity.

The invention further extends to adjusting the viscosity of a curable formulation comprising a said resin and/or a said co-resin, the method comprising adding a portion (or a further portion) of the co-resin, or a portion (or further portion) of the resin, to adjust the viscosity of the curable formulation.

The invention also extends to a kit for preparing a cationically curable formulation, comprising a first and a second curable resin formulation (for example by an end user, according to viscosity requirements of a particular application, accommodating the natural variations of plant oil derived materials);

the first curable resin formulation comprising, or in some embodiments consisting of, a resin (typically an epoxy resin), all, or a substantial part, of the resin comprising the ester fraction of an esterified plant oil (typically an epoxidized esterified plant oil), or derivative thereof, the ester fraction comprising one or more fatty acid esters (typically epoxidized fatty acid esters), or derivatives thereof, wherein each said fatty acid ester is not a mono-, di- or triglyceride;
the second curable resin formulation having a viscosity higher than the viscosity of the first curable resin formulation and comprising, or in some embodiments consisting of, a co-resin (typically an epoxy co-resin), all or a substantial part of the resin comprising a plant oil (typically an epoxidized plant oil), or derivative thereof.

The first and second curable resin formulations may consist of a resin and co-resin, respectively or may comprise further preferred and optional features of the formulations of the first through fourth aspects mentioned above.

The method may comprise adjusting the viscosity of a formulation according to the first through fourth aspects, comprising adding a portion, or further portion, of the co-resin; the co-resin having a viscosity which is higher than the viscosity of the resin and all or a substantial part of the co-resin comprising an epoxidized plant oil; or adding a further portion of the resin.

The resin and co-resin may be epoxy resins and the curable formulation may be cationically photocurable or thermally curable.

In some embodiments, the method comprises the step of providing the ester fractions of one or more further esterified plant oils, or derivatives thereof. Accordingly, the resin may comprise an esterified plant oil blend, the blend comprising the ester fractions of two or more plant oils, or derivatives thereof. In some embodiments, the blend comprises the ester fraction of one or more plant oils, and one or more plant oil derivatives of the same or different plants.

In some embodiments, the method comprises the step of providing a resin comprising at least one unsaturated fatty acid ester, or derivative thereof.

Preferably each said fatty acid ester, or derivative thereof, is the ester of an epoxidized fatty acid ester, or derivative thereof.

Further preferred and optional features of the resin provided by the method of the eighth aspect correspond to preferred and optional features of the resins and co-resins of the first through fourth aspects.

Preferably, the method comprises the step of esterifying one or more fatty acid-based components, to thereby provide the one or more fatty acid esters, or derivatives thereof, of the resin. The method may comprise the steps of esterifying one, or more, or a blend of plant oils, or derivatives thereof, to thereby provide the one or more ester fractions of the resin.

The method may comprise the steps of derivatizing (for example epoxidizing) one or more plant oils, or a blend of plant oils, or the ester fraction of a blend of plant oils, or the ester fractions of one or more plant oils, or one or more fatty acid-based components.

The step of esterifying typically comprises the further step of separating an ester fraction from a glycerol fraction (which may comprise glycerol and/or water), and may, for example comprise the steps of allowing an ester fraction and a glycerol fraction to separate, and drawing off the ester fraction.

Similarly, the step of derivatizing (for example, epoxidizing) may comprise one or more further steps.

The method may be a method of providing a curable coatings formulation (for example an ink, varnish, or wood treatment formulation), which is curable to form a cross-linked coating (for example an ink or varnish or wood treatment). The method may be a method of providing a curable adhesive formulation, curable to form a cross-linked adhesive. The method may be a method of providing a flexographic formulation, suitable to be deposited on a substrate by the method of flexography, or an ink-jettable formulation, suitable to be deposited on a substrate by inkjet printing, or another type of low viscosity coatings formulation.

The method may further comprise the step or steps providing, and/or mixing, one or more of the following; one or more reactive modifiers, one or more passive modifiers, one or more initiators, one or more initiator solvents, one or more pigments, one or more pigment carriers; preferred and optional features of which correspond to preferred and optional features of the first through seventh aspects.

In embodiments comprising the step of providing a pigment the method may comprise the step of providing a co-resin having a higher viscosity than the resin, dispersing the pigment in the all or a portion of the co-resin (for example by milling, or high-shear mixing) to thereby form an ink concentrate, and mixing the ink concentrate with the resin (and other components of the formulation, if present).

In embodiments comprising the step, or steps of providing a co-resin, the co-resin comprising one or more fatty acid-based components, or one or more plant oils, or derivatives thereof, the method may comprise the steps of providing a co-resin, esterifying a portion of the co-resin (and, in some embodiments, extracting the ester fraction therefrom), thereby providing a resin.

Each said fatty acid-based component, and/or each said plant oil, or derivative thereof, and each said fatty acid ester, or derivative thereof, and/or the ester fraction of each said plant oil, or derivative thereof, is mutually miscible.

Accordingly, it will be understood that the method may comprise the further step, or steps, of mixing. Furthermore it will be understood that, in embodiments wherein the method comprises the step of providing a plurality of fatty acid-based components, or plant oils, or derivatives thereof, or fatty acid esters, or derivatives thereof, or the ester fraction of a plurality of plant oils, or derivatives thereof, each said material may be mixed with any combination of other materials of the formulation, at any stage.

As a consequence of the similar chemical behaviour, and mutual miscibility, of the materials comprising the cationically curable formulation, it will be understood that the step or steps of mixing, esterifying and derivatizing (where applicable) may be conducted in any sequence.

The invention extends to a method of preparing a curable formulation, comprising the steps of;

providing a first resin having a first viscosity, comprising a first fatty acid-based component, wherein the fatty acid-based component is a fatty acid, fatty acid mono-, di-, or triglyceride, or derivative thereof;
providing a second resin having a second viscosity which is lower than the first viscosity, comprising a fatty acid ester of a second fatty acid-based component, wherein the fatty acid ester is not a mono-, di- or triglyceride; and
mixing the first resin and the second resin in the proportions required to produce a curable formulation having a predetermined viscosity having a value between the first viscosity and second viscosity.

In some embodiments, the first fatty acid-based component is based on the same fatty acid as the second fatty acid based component. In some embodiments, the first and second fatty acid-based components are the same fatty acid-based component.

The method may comprise the step of providing one or more first plant oil derivatives, and thereby providing a first resin. The method may comprise the step of providing the ester fraction of one or more second plant oil derivatives, and thereby providing a second resin.

In some embodiments, the method comprises the steps of providing a first resin, recovering a portion of the first resin, esterifying the recovered portion of the first resin, thereby providing a second resin.

The method may comprise the steps of:

providing a first plant oil, or a first plant oil blend, or a first fatty acid-based component, or a blend of first fatty acid-based components;
recovering a portion of the said first plant oil, or first plant oil blend, or first fatty acid-based component, or blend of first fatty acid-based components, as the case may be; and
esterifying the said recovered portion, or derivative of thereof, thereby providing a second resin.

Further preferred and optional features of the first and second resins correspond to preferred and optional features of the co-resin and resin.

According to a ninth aspect of the present invention there is provided a method of preparing a cross-linked material, comprising the steps of preparing a curable formulation (such as a cationically curable formulation) according to the eighth aspect; and

curing the formulation to form a cross-linked material.

The step of curing can comprise any suitable method of curing, including but not limited to, drying, heating or irradiating (for example, irradiating with ultraviolet light, or visible light, or an electron beam).

Preferably, the method is a method of preparing a cross-linked coating material, which may be an ink (such as a flexographic ink or an ink jet ink), or a varnish, or an adhesive, or a surface treatment, and comprises the step of applying the curable formulation to a substrate.

The substrate may be any suitable substrate, for example a plastics substrate (such as plastics packaging, or a plastics container), or a wood substrate, or a metal substrate (such as a can), or a paper substrate. The formulation may be applied by any suitable method, for example the curable formulation may be manually applied, or may be applied by flexography, or gravure printing, or ink jet printing, or may be sprayed, or may be painted.

Further preferred and optional features correspond to preferred and optional features of the eighth aspect.

The invention extends to a method of preparing a curable formulation according to the eighth aspect, or a cured cross-linked material according to the fifth through seventh aspects, comprising the steps of planting one or more crops, which is or are preferably non-food crops, on marginal land (such as contaminated land or land having saline soil), obtaining the oil seeds from each said crop, extracting a plant oil from the oil seeds, thereby providing a plant oil.

The invention extends in a tenth aspect to a curable formulation comprising a resin; all, or a substantial part, of the resin comprising one or more fatty acid esters, or derivatives thereof, wherein each said fatty acid ester is not a mono-, di- or triglyceride;

wherein each said fatty acid ester, or derivative thereof is derived from a fatty acid-based component obtained from, or obtainable from, one or more plant oils.

The formulation may be a cationically curable formulation, or a radically curable formulation. The formulation may be a thermally curable formulation. The formulation may be photocurable. The resin may be an epoxy resin.

In some embodiments, the formulation comprises a co-resin (which may, in some embodiments, be an epoxy resin), the co-resin comprising one or more fatty acid-based components obtained from, or obtainable from, one or more plant oils.

Preferred and optional features of the tenth aspect correspond to preferred and optional features of the first through ninth aspects.

The invention extends in an eleventh aspect to a cross-linked material, and in a twelfth aspect to a polymeric material, obtained by cationically curing a cationically curable formulation according to the first through fourth and tenth aspects.

Preferred and optional features of the eleventh and twelfth aspects correspond to preferred and optional features of the first to tenth aspects.

### DETAILED DESCRIPTION OF AN EXAMPLE EMBODIMENT

The invention will now be illustrated by reference to the following examples 1a to 1f of curable formulations suitable for flexographic printing, and which are also suitable for other liquid ink or varnish printing techniques such as gravure printing or ink jet printing.

### Example 1a

### Preparation of a Cationically Photocurable Formulation I

A cationically photocurable flexographic ink formulation I according to the present invention was prepared as follows:

The methyl ester of epoxidized linseed oil was prepared, to function as a cationically curable resin, as follows:

Linseed oil was obtained from flax seeds by cold pressing using a screw filter press.

In their raw state, many plant oils, such as linseed oil, are known to comprise a mixture of fatty-acid based components. The fatty acid-based components exist predominantly as fatty acid triglycerides, with smaller proportions of di- and monoglycerides, and free fatty acids. The oils contain both mixed triglycerides and diglycerides (based upon more than one fatty acid) and triglycerides and diglycerides based upon a single fatty acid. The composition of plant oils may be expressed in terms of the equivalent molar percentages of the free fatty acids, that is to say the molar percentages of the fatty acid units RCO₂, where R is the saturated or unsaturated fatty acid carbon backbone, present in the oil in any form.

Linseed oil typically comprises approximately 19% oleic acid (an 18:1 fatty acid), 24% linoleic acid (an 18:2 fatty acid) and 47% α-linolenic acid (an 18:3 fatty acid). Small amounts of other fatty acids are also present.

The procedure for epoxidising unsaturated plant oils will be well-known to those skilled in the art. The example below is given by way of illustration and is based on the method described in the Journal of Polymer Science, Part A: Polymer Chemistry, 2002, 451-458.

A sample of linseed oil was dissolved in dichloromethane to give a 25 wt % solution of oil in dichloromethane. The solution of oil was cooled in an ice bath and 27 parts of 99% formic acid (CAS 64-18-6) added. 40 parts of hydrogen peroxide (30%) were added over several minutes and the ice bath removed to allow the temperature to rise. After 2 hours the aqueous layer was removed and the epoxidised oil solution washed with sodium bicarbonate solution until all excess acid was neutralised as shown by no further carbon dioxide being evolved. The solution was further washed with sodium hydroxide solution and the oil layer dried over magnesium sulphate. The dichloromethane was removed on a rotary evaporator to leave the epoxidised oil in 95% yield.

The epoxidized linseed oil was then mixed with 25 wt % of methanol, 1 wt % of sodium methoxide and stirred at 50° C. for two hours. The glycerol fraction and methyl ester fraction were allowed to gravity separate and the methyl ester fraction (which we refer to as the methyl ester of epoxidized linseed oil) was drawn off.

The methyl ester of epoxidised linseed oil had a viscosity of less than 5 cP at 25° C.

The pigment PR 48:2 and the methyl ester of epoxidized linseed oil (the resin) were placed in a bead mill in and milled in the presence of zirconia beads at 2000 rpm for 1 hour, to produce a dispersion of the pigment in the resin.

Flexographic ink formulation I was then prepared by adding to the dispersion quantities of the reactive modifiers trimethylpropane oxetane (TMPO), (CAS No. 3047-32-2 obtained from Perstorp AB) and limonene dioxide, (CAS No. 96-08-2 obtained from Sigma Aldrich Co.), which functions in the formulation as a cross linker, dendritic polyester polyol cross linker Boltorn 2004 (CAS No. 462113-22-0, obtained from Perstorp AB), Cyracure 6110 (3,4-epoxy cyclohexyl methyl-3,4 epoxy cyclohexane carboxylate, (CAS No. 2386-87-0), present as a co-resin, obtained from Sigma-Aldrich Co.), and photoinitiators Cyracure 6976 (mixed arylsulphonium hexafluoroantimonateate salts, CAS No. 109037-77-6, obtained from Sigma-Aldrich Co.) and Cyracure 6992 (mixed arylsulphonium hexafluorophosphate salts, CAS No. 109037-77-6, obtained from Univar Products International BV), the flexographic ink having the composition set out in Table 1a. Boltorn is a Trade Mark of Perstorp AB, Perstorp, Sweden.

TABLE 1a
Composition of Flexographioc Ink I

| Weight % | Component |
|---|---|
| 8 | Pigment PR 48:2 |
| 45 | Methyl ester of epoxidized linseed oil resin |
| 20 | Cyracure 6110 co-resin |
| 5 | TMPO reactive modifier |
| 8 | Boltorn 2004 crosslinker |
| 8 | Limonene dioxide crosslinker |
| 2 | Cyracure 6976 photoinitiator |
| 4 | Cyracure 6992 photoinitiator |

The flexographic ink formulation I had a viscosity of <5 cP at 25° C.

### Example 1b

### Preparation of Cationically Photocurable Ink Formulation II

A cationically photocurable flexographic ink formulation according to the present invention was prepared as follows:

A first resin of epoxidized hemp oil was prepared.

A second resin of the methyl ester of epoxidized linseed oil was prepared.

Hemp oil was obtained from hemp seeds by cold pressing using a screw filter press.

Linseed oil was similarly obtained from flax seeds.

Hemp oil typically comprises approximately 8% oleic acid, approximately 54% linoleic acid and approximately 20% α-linolenic acid. Smaller amounts of other fatty acids are also present.

Linseed oil typically comprises approximately 19% oleic acid, 24% linoleic acid and 47% α-linolenic acid (an 18:3 fatty acid). Small amounts of other fatty acids are also present.

The procedure for epoxidising unsaturated plant oils will be well-known to those skilled in the art. The example below is given by way of illustration and is based on the method described in the Journal of Polymer Science, Part A: Polymer Chemistry, 2002, 451-458.

100 parts by weight of hemp oil were dissolved in dichloromethane to give a 25% w/w solution of hemp oil in dichloromethane. The solution of oil was cooled in an ice bath and 27 parts of 99% formic acid added. 40 parts of hydrogen peroxide (30%) were added over several minutes and the ice bath removed to allow the temperature to rise. After 2 hours the aqueous layer was removed and the epoxidised hemp oil solution washed with sodium bicarbonate solution until all excess acid was neutralised as shown by no further carbon dioxide being evolved. The solution was further washed with sodium hydroxide solution and the oil layer dried over magnesium sulphate. The dichloromethane was removed on a rotary evaporator to leave the epoxidised hemp oil in 95% yield.

The first resin (epoxidized hemp oil) had a viscosity of greater than 600 cP at 25° C.

Epoxidized linseed oil was prepared in the manner described above. The epoxidized oil was mixed with 25 wt % of methanol, 1 wt % of sodium methoxide and stirred at 50° C. for two hours. The glycerol fraction and methyl ester fraction were allowed to gravity separate and the methyl ester fraction (which we refer to as the methyl ester of epoxidized linseed oil) was drawn off.

The methyl ester of epoxidised linseed oil had a viscosity of less than 5 cP at 25° C. The methyl ester of epoxidized linseed oil (the second resin) therefore had a considerably lower viscosity than the epoxidized hemp oil (the first resin, or co-resin), described above.

The pigment PR 48:2, the blend of epoxidized hemp oil (the first resin) and the methyl ester of epoxidized linseed oil (the second resin) were placed in a bead mill in the mass ratio of 1 part of pigment:1.9 parts of the first resin:3.75 parts of the second resin, and milled in the presence of zirconia beads at 2000 rpm for 1 hour, to produce a dispersion of the pigment in the mixture of the first and second resins.

Flexographic ink formulation II was then prepared by adding to the dispersion quantities of the reactive modifiers trimethylpropane oxetane (TMPO) and limonene dioxide, which functions in the formulation as a cross linker, dendritic polyester polyol cross linker Boltorn 2004, Cyracure resin 6110, and photoinitiators Cyracure 6976 and Cyracure 6992, the flexographic ink having the composition set out in Table 1b.

TABLE 1b
Composition of Flexographic Ink II

| Weight % | Component |
|---|---|
| 8 | Pigment PR 48:2 |
| 15 | Epoxidized hemp oil resin |
| 30 | Methyl ester of epoxidized linseed oil resin |
| 20 | Cyracure 6110 resin |
| 5 | TMPO reactive modifier |
| 8 | Boltorn 2004 crosslinker |
| 8 | Limonene dioxide crosslinker |
| 2 | Cyracure 6976 photoinitiator |
| 4 | Cyracure 6992 photoinitiator |

The flexographic ink formulation II had a viscosity of 5 cP at 25° C.

### Example 1c

### Preparation of Cationically Thermally Curable Varnish Formulation III

A cationically thermally curable flexographic varnish formulation according to the present invention was prepared as follows:

A first resin of epoxidized linseed oil, and a second resin of the methyl ester of epoxidized linseed oil, were prepared according to the methods discussed above.

The first resin (epoxidized linseed oil) had a viscosity of approximately 500 cP at 25° C. The viscosity of linseed oil (epoxidized or in its raw state) typically falls in the range 350 cP-600 cP and therefore the relative proportions of linseed oil and the methyl ester of linseed oil may be adjusted accordingly.

The methyl ester of epoxidised linseed oil had a viscosity of less than 5 cP at 25° C.

Flexographic varnish formulation III was then prepared by mixing the resins with quantities of soya oil (soya oil typically comprising approximately 25% oleic acid, approximately 55% linoleic acid approximately 7% α-linolenic acid, and smaller amounts of other fatty acids), rosin, polythene wax and a cationic thermal initiator, cobalt tallate (CAS No. 61789-52-4) in the proportions set out in Table 1c.

TABLE 1c
Composition of Flexographic Varnish III

| Weight % | Component |
|---|---|
| 23 | Soya oil |
| 15 | Epoxidized linseed oil resin |
| 15 | Methyl ester of epoxidized linseed oil resin |
| 42 | Rosin |
| 3 | Polythene wax |
| 2 | Cobalt tallate |

The flexographic varnish III had a viscosity of 5 cP at 25° C.

### Example 1d

### Preparation of Cationically Thermally Curable Varnish Formulation IV

A cationically thermally curable flexographic varnish formulation according to the present invention was prepared as follows:

A first resin of epoxidized linseed oil, and a second resin of the methyl ester of epoxidized linseed oil, were prepared according to the methods discussed above.

The first resin (epoxidized linseed oil) had a viscosity of approximately 50 cP at 25° C.

The methyl ester of epoxidised linseed oil had a viscosity of less than 5 cP at 25° C.

Flexographic varnish formulation IV was then prepared by mixing the resins with quantities of a further Cyracure resin, reactive diluents limonene dioxide and TMPO, and cross linker Boltorn 2004, together with thermal initiator Omnicat 440, in the proportions set out in Table 1d.

TABLE 1d
Composition of Flexographic Varnish IV

| Weight % | Component |
|---|---|
| 23 | Epoxidized linseed oil resin |
| 15 | Methyl ester of epoxidized linseed oil resin |
| 46 | Cyracure 6105 |
| 5 | Omnicat 440 |
| 1 | Limonene dioxide |
| 8 | Boltorn 2004 |
| 2 | TMPO |

The flexographic varnish IV had a viscosity of 5 cP at 25° C.

### Example 1e

### Cationically Photocurable Varnish Formulation V

We have also prepared varnish composition V, based upon the resin and co-resin described above in relation to Example 1a, with the composition set out in Table 1e.

TABLE 1e

| Weight % | Component |
|---|---|
| 50 | Methyl ester of epoxidised linseed oil resin |
| 15 | Cyracure 6110 co-resin |
| 10 | Boltorn 2004 crosslinker |
| 10 | TMPO reactive modifier |
| 10 | Limonene dioxide crosslinker |
| 5 | Cyracure 6976 photoinitiator |

### Example 1f

### Varnish Formulation VI

We have also prepared varnish composition VI, based upon the resins described above in relation to Example 1b, with the composition set out in Table 1f.

We have also demonstrated the use of alternative resins, in varnishes similar to example 1e, substituting the methyl ester fraction of epoxidized linseed oil for the methyl ester fraction of epoxidized rapeseed oil, or epoxidized soya oil.

TABLE 1f

| Weight % | Component |
|---|---|
| 16 | Epoxidized hemp oil resin |
| 33 | Methyl ester of epoxidized linseed oil resin |
| 22 | Cyracure 6110 resin |
| 5.4 | TMPO reactive modifier |
| 8.7 | Boltorn 2004 crosslinker |
| 8.7 | Limonene dioxide crosslinker |
| 2.1 | Cyracure 6976 photoinitiator |
| 4.1 | Cyracure 6992 photoinitiator |

We have demonstrated the use of alternative first resins, in varnishes similar to example 1f, comprising alternative epoxidized plant oils, or blends of plant oils, substituting the epoxidized hemp oil for a blend of epoxidized borage oil and epoxidized castor oil in approximately 70:30 ratio.

We have also demonstrated the use of alternative second resins in varnishes similar to example 1f, substituting the methyl ester fraction of epoxidized linseed oil for the methyl ester fraction of epoxidized rapeseed oil, or epoxidized soya oil.

### Example 2

### Preparation of Known Curable Formulation

A typical known cationically curable flexographic ink formulation was prepared. Pigment PR 48:2 was dispersed in Cyracure 6110 resin, in a bead mill, and a flexographic ink formulation was then prepared by adding to the dispersion quantities of TMPO reactive diluent, Boltorn 2004 crosslinker, Omnicat 550 photoinitiator (10-[1,1′-biphenyl]-4-yl-2-(1-methylethyl)-9-oxo-9H-thioxanthenium hexafluorophosphate, (CAS No. 591773-92-1), obtained from IGM Resins B.V.) (Omnicat is a Trade Mark of IGM Resins B. V., Waalwijk, The Netherlands), Solsperse 5000 dispersant and Solsperse 39000 dispersant (obtained from Lubrizol Ltd.) (Solsperse is a Trade Mark of Lubrizol Advanced Materials Inc., Ohio, USA) and polyether modified polydimethylsiloxane BYK307 (obtained from BYK-Chemie Gmbh), the flexographic ink having the composition set out in Table 2.

TABLE 2

| Weight % | Component |
|---|---|
| 8 | Pigment PR 48:2 |
| 60 | Cyracure 6110 resin |
| 12 | TMPO reactive diluent |
| 10 | Boltorn 2004 crosslinker |
| 8 | Omnicat 550 photoinitiator |
| 0.3 | Solsperse 5000 |
| 1.4 | Solsperse 39000 |
| 0.3 | BYK307 |

The conventional flexographic ink formulation, with the composition set out in Table 2, has a viscosity of >600 cP at 25° C.

### Example 3

### Preparation of Cured, Cross-Linked Materials

The photocurable inks were deposited on orientated polypropylene (OPP) substrate and irradiated with a Dimex 400 W UV light source, to produce cured ink coating materials I and II.

The thermally curable varnishes were deposited on an OPP substrate and cured in a drying oven at 120° C. for 30 minutes, to produce cured varnish coating materials III and IV. The rate of curing may be varied by raising the curing temperature and the formulations are typically cured at temperatures in the range of 120-150° C. for 20 minutes (at 150° C.) to 30 minutes (at 120° C.).

### Example 4

### Characterization of Cured, Cross Linked Materials

The resulting cured coating materials I to IV were then subject to a number of standard industry tests, set out below. These tests demonstrate that, whereas the curable formulations of the present invention, with the compositions set out in Tables 1a to 1d, have a lower viscosity, and optionally a considerably lower viscosity than a typical known curable or cationically formulation, such as the formulation with a composition set out in Table 2, the cured coatings obtained from each of the formulations demonstrate comparable performance.

### Surface Adhesion Test (BS 3900 E6)

Two passes of a 1 mm cross hatch cutter were made across each coating perpendicular to each other, to produce a square lattice pattern. Adhesive tape was evenly applied to each cut lattice section and removed. The lattice cut areas were then assessed for resistance of separation of the coating from the substrate, and the extent of adhesion assessed by counting the number of squares removed by the tape.

The coatings prepared from the formulation shown in Tables 1a to 1d showed 100% adhesion, i.e. none of the ink formulation was removed by the tape.

The coating prepared from the conventional formulation shown in Table 2 also showed 100% adhesion.

Thus, the formulation of the present invention yielded coatings with comparable surface adhesion properties to the conventional formulation with a composition as shown in Table 2.

### Solvent Resistance (ASTM D4752)

A swab saturated with methylethyl ketone was rubbed to and fro over a test piece using a standard pressure (1 kg) and the number of rubs counted until the film shows signs of swell, detachment or dissolution

The formulations I-VI shown in Tables 1a to 1f showed no sign of attack after 200 double rubs.

The formulation shown in Table 2 showed no sign of attack after 200 double rubs.

Thus, the formulations of the present invention yielded a coating with comparable solvent resistance to the conventional formulation with a composition as shown in Table 2.

### Surface Hardness (“Pencil Test”, BS 3900:E19:1999)

A sample of the coated film was scored with pencils of differing hardness up to the maximum of 6H and then examined for evidence that the film had been penetrated to the substrate

The formulations I-VI in Table 1a to 1f showed no penetration at 6H hardness

The formulation shown in Table 2 showed no penetration at 6H hardness.

Thus, the formulations of the present invention yielded coatings with comparable hardness to the conventional formulation, with a composition as shown in Table 2.

### Example 6

### Alternative Preparations

In alternative preparations, we have transesterified the plant oil and epoxidized the obtained methyl ester fraction. However, we have observed that the rate of separation of the glycerol and methyl ester fractions of is greater if the oil is first epoxidized.

We have demonstrated the use of alternative resins in formulations similar to example 1a, substituting the methyl ester fraction of epoxidized linseed oil for the methyl ester fraction of epoxidized rapeseed oil, or epoxidized soya oil.

We have also demonstrated the use of alternative first resins, in formulations similar to example 1b, comprising alternative epoxidized plant oils, or blends of plant oils, substituting the epoxidized hemp oil for a blend of epoxidized borage oil and epoxidized castor oil in approximately 70:30 ratio.

Borage oil typically comprises approximately 18% oleic acid (an 18:1 fatty acid), approximately 32% linoleic acid (an 18:2 fatty acid) and approximately 24% γ-linolenic acid (an 18:3 fatty acid). Small amounts of other fatty acids are also present.

Castor oil typically comprises approximately 85% ricinoleic acid (an 18:1 fatty acid), approximately 6% oleic acid and approximately 5% linoleic acid, and smaller amounts of other fatty acids.

We have also demonstrated the use of alternative second resins in formulations similar to example 1b, substituting the methyl ester fraction of epoxidized linseed oil for the methyl ester fraction of epoxidized rapeseed oil, or epoxidized soya oil.

Rapeseed oil typically comprises approximately 60% oleic acid, approximately 20% linoleic acid approximately 10% α-linolenic acid, and smaller amounts of other fatty acids.

The formulations I-VI may also be readily reformulated by adjusting the relative proportions of the constituents, so as to provide formulations having higher or lower viscosities. For example, the viscosity of formulations comprising both an epoxidized plant oil resin and a methyl ester fraction of an esterified epoxidized plant oil resin (such as formulations II, III, IV and VI, above) may be adjusted by the addition of further quantities of one or other of the resins, or the formulations may be prepared to an alternative predetermined viscosity by varying the relative proportions of the resins.

Further variations and modifications may be made within the scope of the invention herein disclosed.

1. A cationically curable formulation comprising an epoxy resin; all, or a substantial part, of the resin comprising the ester fraction of an epoxidized esterified plant oil, or derivative thereof, the ester fraction comprising one or more epoxidized fatty acid esters, or derivatives thereof, wherein each said fatty acid ester is not a mono-, di- or triglyceride.

2. A formulation according to claim 1, wherein the or each said fatty acid ester, or derivative thereof, is an alkyl ester.

3. A formulation according to claim 1, wherein the or each said fatty acid ester, or derivative thereof, is a methyl ester.

4. A formulation according to claim 1, wherein the resin comprises the ester fractions of one or more further epoxidized esterified plant oils, or derivatives thereof.

5. A low viscosity coating formulation according to any claim 1.

6. A flexographic coating formulation according to claim 1, suitable for flexographic printing applications and which is curable to form a cross-linked coating.

7. An ink jet formulation according to claim 1, suitable for inkjet printing applications, and which is curable to form a cross-linked coating.

8. A photocurable formulation according to claim 1, which is curable to form a cross-linked material in response to light.

9. A thermally curable formulation according to claim 1, which is curable to form a cross-linked material in response to a rise in temperature.

10. A formulation according to claim 1, further comprising a cationic initiator.

11. A formulation according to claim 10, wherein the cationic initiator is a cationic photoinitiator which, in use, reacts so as to initiate curing in response to light or a thermal initiator which, in use, reacts so as to initiate curing in response heat, to form a super acid.

12. A formulation according to claim 10, wherein the cationic initiator is a cationic thermal initiator comprising a fatty acid metal salt.

13. A formulation according to claim 1 further comprising an epoxy co-resin, all or a substantial portion of the co-resin comprising an epoxidized plant oil, or derivative thereof.

14. A formulation according to claim 13, wherein the co-resin has a higher viscosity than the resin.

15. A formulation according to claim 13, wherein, the ester fraction of an epoxidized esterified plant oil, or derivative thereof, of the resin, is an ester fraction of an epoxidized esterified oil of the same plant as the plant oil, or derivative thereof, of the co-resin.

16. A formulation according to claim 13, wherein the co-resin comprises a blend of epoxidized esterified plant oils, or derivatives thereof.

17. A curable ink formulation according to claim 1, further comprising one or more pigments.

18. An ink concentrate for mixing with a curable formulation comprising an epoxy resin, all, or a substantial part, of the resin comprising the ester fraction of an epoxidized esterified plant oil, or derivative thereof, the ester fraction comprising one or more epoxidized fatty acid esters, or derivatives thereof, wherein each said fatty acid ester is not a mono-, di- or triglyceride; to form a curable ink formulation;
the ink concentrate comprising a pigment dispersed in a pigment carrier, all or a substantial part of the pigment carrier comprising an epoxidized plant oil, or derivative thereof.

19. An ink concentrate for mixing with an epoxy resin and an epoxy co-resin to form a curable ink formulation; the ink concentrate comprising a pigment dispersed in a portion of the co-resin, all or a substantial portion of the co-resin comprising an epoxidized plant oil, or derivative thereof.

20. A curable ink formulation comprising a curable formulation according to claim 1 or an ink concentrate for mixing with a curable formulation comprising an epoxy resin, all, or a substantial part, of the resin comprising the ester fraction of an epoxidized esterified plant oil, or derivative thereof, the ester fraction comprising one or more epoxidized fatty acid esters, or derivatives thereof, wherein each said fatty acid ester is not a mono-, di- or triglyceride; to form a curable ink formulation; the ink concentrate comprising a pigment dispersed in a pigment carrier, all or a substantial part of the pigment carrier comprising an epoxidized plant oil, or derivative thereof.

21. A cross-linked material comprising a cationically cured epoxy resin;
the cross-linked material having chemical cross linking between constituents resin;
all, or a substantial part, of the resin comprising the ester fraction of an epoxidized esterified plant oil, or derivative thereof, the ester fraction comprising one or more epoxidized fatty acid esters, or derivatives thereof, wherein each said fatty acid ester is not a mono-, di- or triglyceride.

22. A cross-linked material according to claim 22, wherein the or each said fatty acid ester, or derivative thereof, is an alkyl ester.

23. A cross-linked material according to claim 22, wherein the or each said fatty acid ester, or derivative thereof, is a methyl ester.

24. A cross-linked material comprising a cationically cured mixture of an epoxy resin and an epoxy co-resin;
all, or a substantial part, of the resin comprising the ester fraction of an epoxidized esterified plant oil, or derivative thereof, the ester fraction comprising one or more epoxidized fatty acid esters, or derivatives thereof, wherein each said fatty acid ester is not a mono-, di- or triglyceride.
all or a substantial portion of the co-resin comprising an epoxidized plant oil, or derivative thereof;
the cross-linked material having chemical cross linking between constituents of the resin, between constituents of the co-resin, and between constituents of the resin and co-resin.

25. A method of preparing a cationically curable formulation, comprising the step of;
providing an epoxy resin, all, or a substantial part, of the resin comprising the ester fraction of an epoxidized esterified plant oil, or derivative thereof, the ester fraction comprising one or more epoxidized fatty acid esters, or derivatives thereof, wherein each said fatty acid ester is not a mono-, di- or triglyceride.

26. A method according to claim 25, comprising the step of providing an epoxy co-resin having a higher viscosity than the resin; all or a substantial portion of the co-resin comprising an epoxidized plant oil, or derivative thereof; and mixing the resin and a co-resin.

27. A method according to claim 26, of preparing a curable formulation of a predetermined viscosity, comprising the steps of providing an epoxy resin having a first viscosity, all or a substantial portion of the resin comprising the ester fraction of an epoxidized esterified plant oil, wherein the ester fraction does not comprise a mono-, di- or triglyceride; providing an epoxy co-resin resin having a second viscosity which is higher than the first viscosity, all or a substantial portion of the co-resin comprising an epoxidized plant oil, or derivative thereof; and
mixing the resin and the co-resin in the proportions required to produce a curable formulation having a predetermined viscosity having a value between the first viscosity and second viscosity.

28. A method according to claim 25, comprising providing an epoxy-co-resin having a viscosity higher than the viscosity of the resin; all or a substantial portion of the co-resin comprising an epoxidized plant oil, or derivative thereof; dispersing a pigment in a portion or all of the co-resin to form an ink concentrate, and mixing the ink concentrate with the formulation to thereby provide a cationically curable ink formulation.

29. A method according to claim 25, wherein each said ester is a methyl ester.

30. A method according to claim 25, comprising the step or steps of providing one or more of the following; one or more reactive modifiers, one or more passive modifiers, one or more initiators, one or more initiator solvents, one or more pigments, one or more pigment carriers.

31. A method of preparing a cross-linked material, comprising the steps of preparing a cationically curable formulation according to the method of claim 25; and
cationically curing the formulation to form a cross-linked material.

32. A method according to claim 31, comprising the step of curing by irradiating with light or raising the temperature.

33. A method of preparing a cross-linked coating material according to claim 31, comprising the step of applying the curable formulation to a substrate.

34. A method of adjusting the viscosity of a curable formulation according to claim 1, comprising adding a portion, or further portion, of the co-resin; the co-resin having a viscosity which is higher than the viscosity of the resin and all or a substantial part of the co-resin comprising an epoxidized plant oil;
or adding a further portion of the resin.

35. A cationically curable formulation comprising an epoxy resin;
all, or a substantial part, of the resin comprising one or more epoxidized fatty acid esters, or derivatives thereof, wherein each said fatty acid ester is not a mono-, di- or triglyceride;
wherein each said fatty acid ester, or derivative thereof is derived from a fatty acid-based component obtained from, or obtainable from, one or more plant oils.

36. A kit for a curable ink formulation, comprising an ink concentrate and a curable formulation;
the curable formulation comprising an epoxy resin, all, or a substantial part, of the resin comprising the ester fraction of an epoxidized esterified plant oil, or derivative thereof, the ester fraction comprising one or more epoxidized fatty acid esters, or derivatives thereof, wherein each said fatty acid ester is not a mono-, di- or triglyceride;
the ink concentrate comprising a pigment dispersed in a pigment carrier, the pigment carrier having a higher viscosity than the resin, all or a substantial part of the pigment carrier comprising an epoxidized plant oil, or derivative thereof.

37. A kit according to claim 36, further comprising second curable resin formulation, the second curable resin formulation comprising an epoxy co-resin, all or a substantial portion of the co-resin comprising an epoxidized plant oil, or derivative thereof.

38. A kit according to claim 37, wherein the pigment carrier is a portion of the co-resin.

39. A kit for a cationically curable formulation, comprising a first and a second curable resin formulation;
the first curable resin formulation comprising an epoxy resin, all, or a substantial part, of the resin comprising the ester fraction of an epoxidized esterified plant oil, or derivative thereof, the ester fraction comprising one or more epoxidized fatty acid esters, or derivatives thereof, wherein each said fatty acid ester is not a mono-, di- or triglyceride;
the second curable resin formulation having a viscosity higher than the viscosity of the first curable resin formulation and comprising an epoxy co-resin, all or a substantial part of the co-resin comprising an epoxidized plant oil, or derivative thereof.
